(19) United States
(12) Patent Application Publication
(10) Pub. No.: US 2014/0286002 A1
(43) Pub. Date: Sep. 25, 2014

(54) ELECTRONIC CIGARETTE CASE

(71) Applicant: Qiuming Liu, Shenzhen City (CN)

(72) Inventor: Qiuming Liu, Shenzhen City (CN)

(21) Appl. No.: 14/235,043

(22) PCT Filed: Mar. 19, 2013
(86) PCT No.: PCT/CN2013/072870

§ 371 Date: Jan. 24, 2014

(51) Int. Cl. A24F 47/00; F21V 33/00

(52) U.S. Cl. CPC A24F 47/002; F21V 33/0004
USPC 362/154

(57) ABSTRACT

An electronic cigarette case of the invention, includes a case body and a case cover interconnected, an illuminating lamp is set in the case cover, a battery is set in the case body, the illumination lamp is electrically connected with the battery to form an illumination circuit, first and second switch contacts in the illumination circuit are independent and touchable, the case cover is set with a cover cam, the cam can push the first switch contact away from the second switch contact. The case has illumination device, can realizes illumination function; the illumination device has switch corresponding to the cover being open or closed, when the cover open, the illuminating lamp is on, thus the user can clearly see the atomizer, power rod and the electronic cigarette, which brings convenience to the user; when the cover closed, the illuminating lamp is off, which saves power, and prolongs using life.

### BACKGROUND OF THE INVENTION

1. Field of the Invention

The present invention relates to an electronic cigarette, and particularly to an electronic cigarette case equipped with an illumination device.

2. Related Art

As people pay more attention to health, they are aware that smoking harms body, electronic cigarette is accordingly generated. The electronic cigarette vaporizes cigarette liquid for the smoker usually by means of an atomizer, harmful components such as nicotine and tar have been removed from the cigarette liquid, after people uses electronic cigarette, smoking dependency will gradually be reduced, so the electronic cigarette can assist the user giving up smoking.

For meeting the habit of the smoker, and for conveniently placing or taking electronic cigarette, generally, the electronic cigarette is placed in a suitable electronic cigarette case. The usual electronic cigarette case includes a main body and a cover which is able to be flapped to open. Under some situations, the user uses the electronic cigarette in dim light, he cannot see or cannot clearly see when he takes out the electronic cigarette, so it is inconvenient.

Therefore, it is desirable to provide an electronic cigarette case with an illumination device.

### SUMMARY OF THE INVENTION

An object of the present invention is to provide an electronic cigarette case with an illumination device.

To achieve the above object, an electronic cigarette case is provided in the present invention, comprising a case body and a case cover connected to each other; an illuminating lamp is set within the case cover, a battery is set within the case body, the illuminating lamp and the battery are connected to form an illumination circuit, the illumination circuit is provided with a first switch contact and a second switch contact both of which are independent and electrically touchable with each other; the case cover is further provided with a cover cam, the cover cam is able to push the first switch contact away from the second switch contact when the case cover is closed.

When the electronic cigarette case is closed, the cover cam pushes the first switch contact, thus the first switch contact departs from the second switch contact, both switch contacts are out of touch with each other, thereby, the illumination circuit is open, and the illuminating lamp is off.

When the electronic cigarette case is open, the case cover is rotated to open, the cover cam is rotated away from the first switch contact, thus the first switch contact and the second switch contact get in touch with each other, thereby the illumination circuit is closed, and the illuminating lamp is on, which obtains illumination.

The electronic cigarette case of the present invention is equipped with such illumination device, which can obtain illumination effect; meanwhile, the illumination device is provided with such switch means corresponding to the case cover being open or closed; when the case cover is open, the illuminating lamp is on, thus the user can clearly see the atomizer, power rod and the electronic cigarette, which brings more convenience to the user; when the case cover is closed, the illuminating lamp is off, which saves power, and prolongs its using life as well.

Preferably, the electronic cigarette case is equipped with a frame assembly therein, the first switch contact and the second switch contact each have one end thereof respectively fixed on the frame assembly, and the other end of the first switch contact extends to an opposite position to the cam. The frame assembly is proposed for conveniently fixing the first switch contact and the second switch contact, and also for a convenient circuit layout for the battery.

Preferably, the end of each the first switch contact and the second switch contact is fixed on the frame assembly respectively via two fixed pivots, by which the first switch contact and the second switch contact are more firmly fixed, and the first switch contact generates more satisfactory deformation due to the cover cam; furthermore, when the first switch contact and the second switch contact get in touch, and the cover cam and the first switch contact are engaged with each other, an accurate clutch relation is available, which ensures switch sensitivity.

Preferably, the end of each the first switch contact and the second switch contact is fixed on the frame assembly respectively by rivets, welding, or screws.

Preferably, the first switch contact and the second switch contact perpendicularly cross each other, in such way, when the first switch contact and the second switch contact get in touch, and the cover cam and the first switch contact are engaged with each other, an accurate clutch relation is available, which ensures switch sensitivity.

Preferably, the cover cam is set at a junction of the case cover with the case body.

Preferably, the case cover is engaged with the case body by a hinge, and the cam is set to an inner wall of the case cover corresponding to the hinge. When the electronic cigarette is closed, the cover cam holds down the free end of the first switch contact, thus the first switch contact generates deformation, being deformed outwards at which was originally touched with the second switch contact, then the first switch contact departs from the second switch contact, both switch contacts are out of touch with each other, thereby, the illumination circuit is open, and the illuminating lamp is off When the electronic cigarette case is open, the case cover is rotated to open, the cover cam is rotated away from the first switch contact, thus the first switch contact is restored in shape without deformation any more, thus the first switch contact and the second switch contact get in touch with each other, thereby the illumination circuit is closed, and the illuminating lamp is on, which obtains illumination.

Preferably, the cover cam is a protrusion with an arc surface of smooth transition, thus the cover cam is engaged with the first switch contact without mechanical friction, and able to make the first switch contact deformed, prolongs its using life.

Preferably, the frame assembly comprises an electronic cigarette holder for placing the electronic cigarette. Preferably, the electronic cigarette holder defines multiple holes adapted for the electronic cigarette, power rod of the electronic cigarette, or atomizer of the electronic cigarette, which are able to respectively accommodate the electronic cigarette, power rod of the electronic cigarette, or atomizer of the electronic cigarette.

Preferably, a frame insulator is provided on the electronic cigarette holder, and the frame insulator in center defines a through hole adapted for the electronic cigarette, power rod of the electronic cigarette, or an atomizer of the electronic cigarette. The frame insulator supplies insulation between the electronic cigarette, the power rod or the atomizer of electronic cigarette and the illumination circuit.

Preferably, the electronic cigarette holder comprises an upper holder and a lower holder, and the frame insulator is placed between the upper holder and the lower holder. Preferably, the frame insulator is aligned to both the upper holder and a lower holder.

Preferably, the frame assembly further comprises an insulator of the power rod adapted for the power rod of the electronic cigarette, which provides insulation between the power rod and other elements.

Preferably, the frame insulator and the insulator of the power rod are made from silica gel.

Preferably, the illuminating lamp is an LED lamp.

Compared with the prior art, the present invention has at least the advantages as follows: the electronic cigarette case of the present invention has illumination device, can realizes illumination function; meanwhile, the illumination device is provided with such switch means corresponding to the case cover being open or closed, when the case cover is open, the illuminating lamp is on, thus the user can clearly see the atomizer, power rod and the electronic cigarette, which brings convenience to the user; when the case cover is closed, the illuminating lamp is off, which saves power, and prolongs its using life as well.

### BRIEF DESCRIPTION OF THE DRAWINGS

FIG. 1 is a front, exploded and perspective view of an electronic cigarette case in accordance with an embodiment of the present invention;

FIG. 2 is a rear, exploded and perspective view of the electronic cigarette case in accordance with the embodiment of the present invention;

FIG. 3 is an exploded and perspective view of the electronic cigarette case in accordance with the embodiment of the present invention;

FIG. 4 is a cross-sectional view of the electronic cigarette case in a first-state in accordance with the embodiment of the present invention;

FIG. 5 is a cross-sectional view of the electronic cigarette case in a second-state in accordance with the embodiment of the present invention;

FIG. 6 is an enlarged view of an A portion indicated in FIG. 4;

FIG. 7 is an enlarged view of a B portion indicated in FIG. 5; and

FIG. 8 is a perspective view of the electronic cigarette case in accordance with the embodiment of the present invention.

### DESCRIPTION OF THE PREFERRED EMBODIMENTS

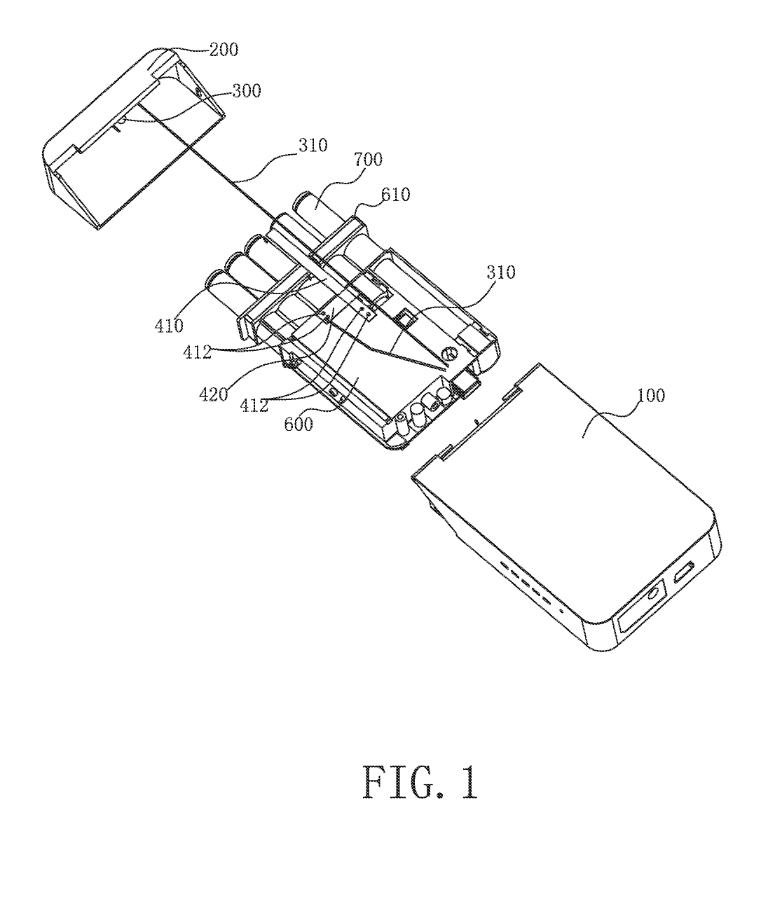

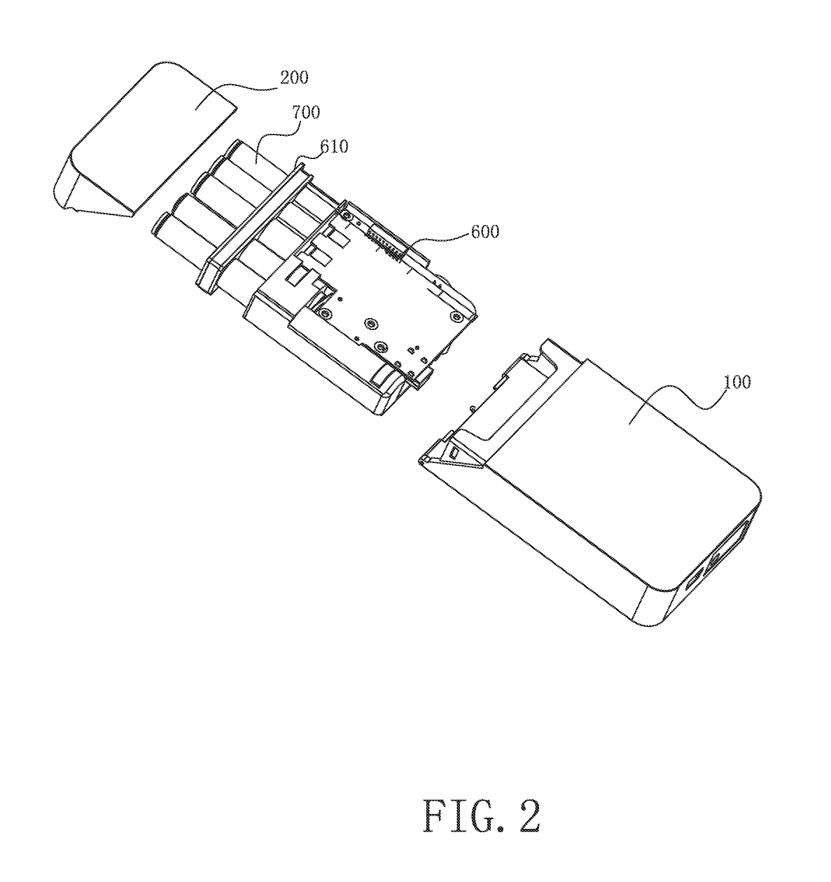

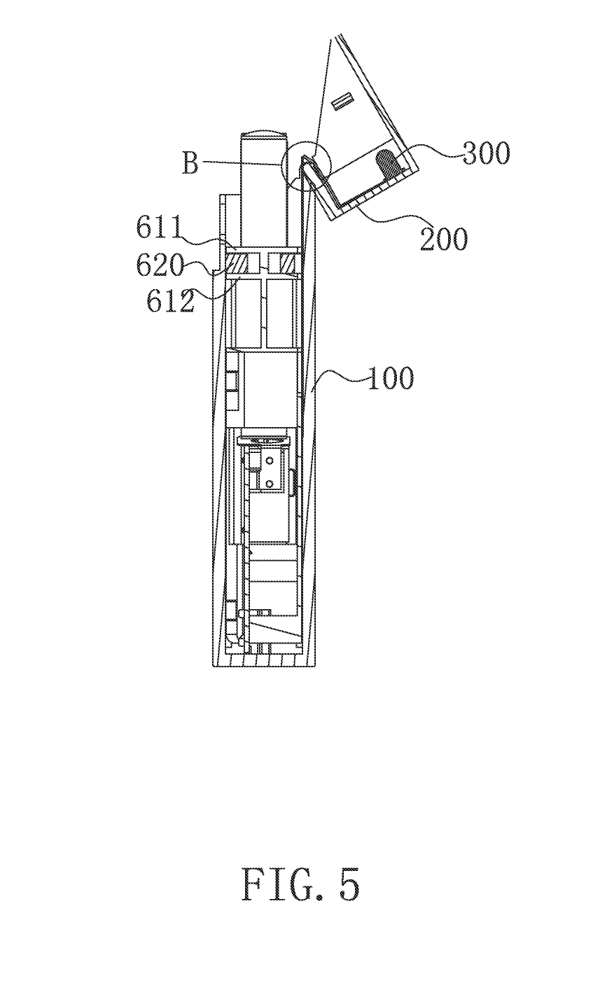

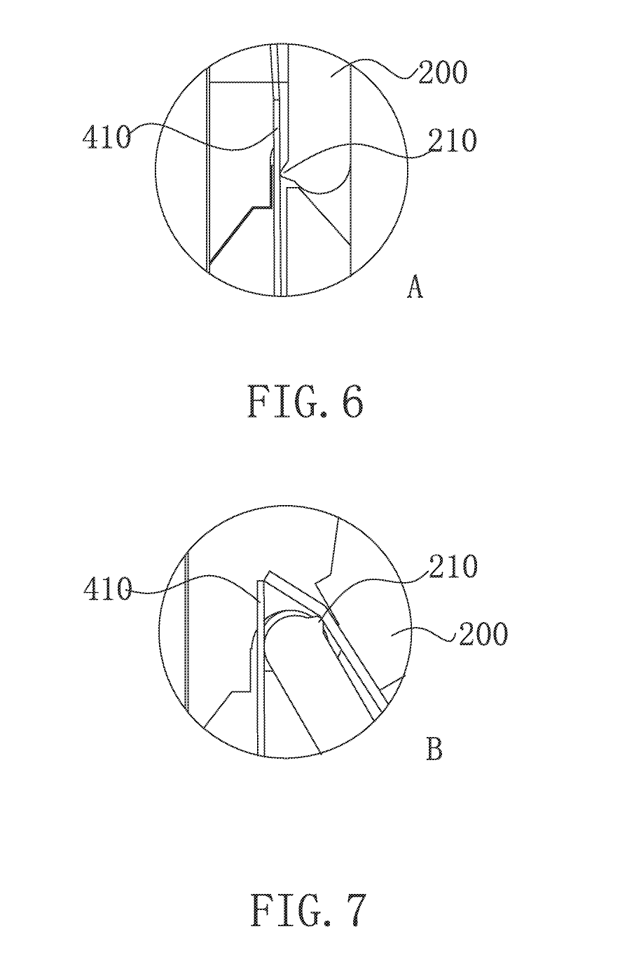

Referring to FIGS. 1 to 7, the present invention is to provide an electronic cigarette case; comprising a case body 100 and a case cover 200 both of which are connected with each other. The case cover 200 is equipped with an LED lamp 300 therein. The case body therein is equipped with a frame assembly 600 and a battery 500. The lamp 300 is electrically connected with the battery 500 via wire 310 to form an illumination circuit, and a first switch contact 410 and a second switch contact 420 are independently but touchably set in the illumination circuit. The case cover 200 is further set with a cover cam 210, and the cover cam 210 is able to propel the first switch contact 410 away from the second switch contact 420 when the case cover 200 is closed. The first switch contact 410 and the second switch contact 420 respectively have one end thereof fixed on the frame assembly 600, and the other end of the first switch contact 410 extends to an opposite position to the cover cam 210.

As shown in FIGS. 1-3, one end of each the first switch contact 410 and the second switch contact 420 is fixed on the frame assembly 600 respectively via two fixed pivots 412, so that the first switch contact 410 and the second switch contact 420 respectively have one end thereof fixed on the frame assembly 600, the first switch contact 410 and the second switch contact 420 are fixed more tightly, which insures the sensitivity of switch means. The first switch contact 410 and the second switch contact 420 are perpendicularly intercross; so that when the first switch contact 410 and the second switch contact 420 get touched each other, and the cover cam is engaged with the first switch contact, a precise clutch relationship is available which ensures the sensitivity of switch means.

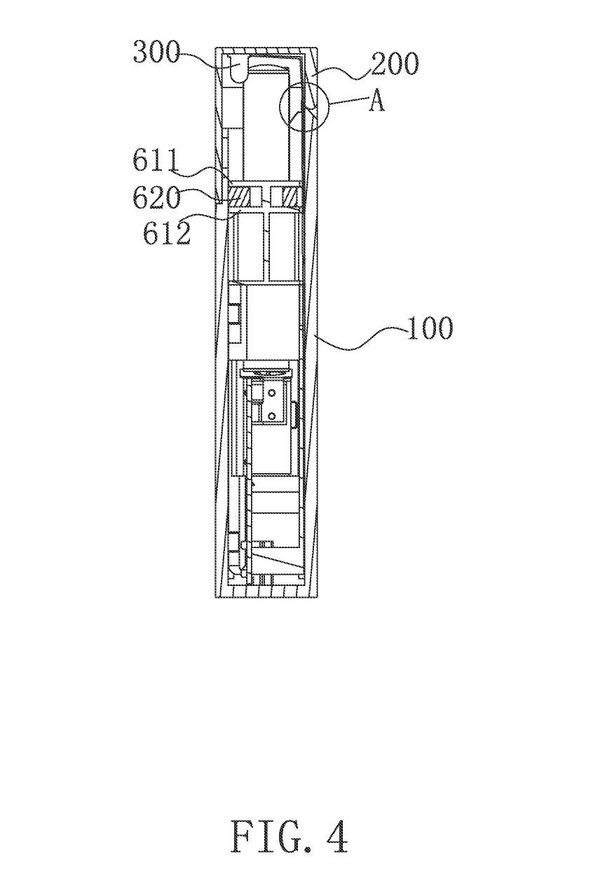

Together referring to FIGS. 4-7, the case cover 200 is engaged with the case body 100 by a hinge, and the cover cam 210 is set on inner wall of the case cover corresponding to the hinge. When the case cover 200 is closed, the cover cam holds down a free end of the first switch contact 410, thus the first switch contact is deformation, being deformed outwards at which was originally touched with the second switch contact 420, therefore, the first switch contact 410 departs from the second switch contact 420, both contacts are untouched, the illumination circuit is disconnected and the lamp is out. When the case cover 200 is open, and the case cover is rotated away, then the cover cam 210 rotates away the first switch contact 410, the first switch contact 410 is no longer deformation but restores itself, thus the first switch contact 410 and the second switch contact 420 get touched again, in such way that the illumination circuit is connected, the lamp is on, and lighting is available.

The cover cam 210 is a protruding with an arc surface of smooth transition, so that the cover cam 210 is engaged with the first switch contact 410 without mechanical abrasion and ensures the first switch contact a deformation and a longer service life.

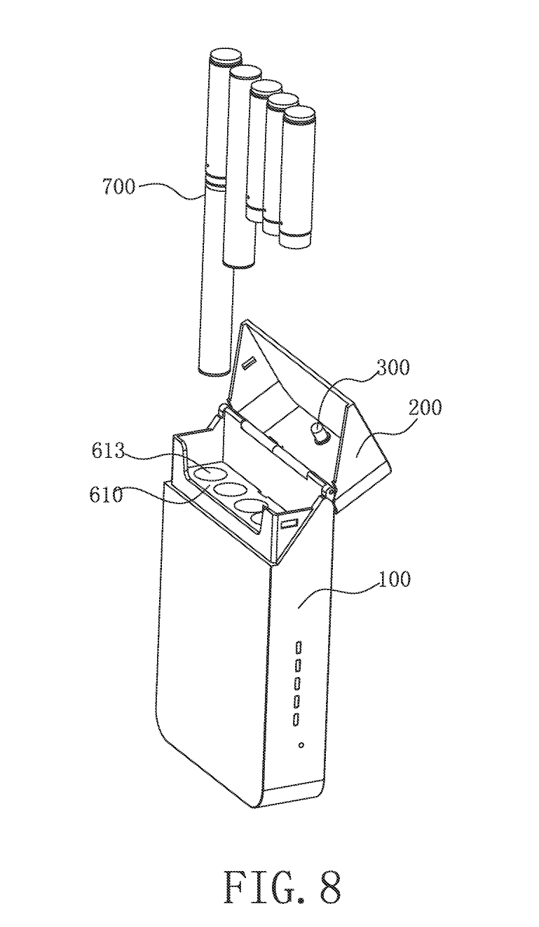

Referring to FIGS. 1-3 and FIG. 8, the frame assembly 600 comprises an electronic cigarette holder 610 for placing the electronic cigarette, the electronic cigarette holder 610 comprises an upper holder 611 and a lower holder 612, an frame insulator 620 is provided between the upper holder and a lower holder, and the frame insulator 620 is aligned to both the upper holder 611 and a lower holder 612. The electronic cigarette holder 610 defines multiple holes 613 adapted for electronic cigarette 700, power rod 710 of the electronic cigarette or atomizer 720 of electronic cigarette; the frame insulator 620 in center defines a through hole 621 adapted for the electronic cigarette 700, the power rod 710 or the atomizer 720 of electronic cigarette, which can accommodate the electronic cigarette 700, the power rod 710 or the atomizer 720 of electronic cigarette. The frame insulator 320 supplies insulation between the electronic cigarette, the power rod or the atomizer 720 of electronic cigarette and the illumination circuit. The frame assembly further comprises an insulator 630 of power rod adapted for the power rod of the electronic cigarette, which supplies insulation between the power rod and other elements. The frame insulator 620 and the insulator 630 of power rod may be made from silica gel or other insulation materials.

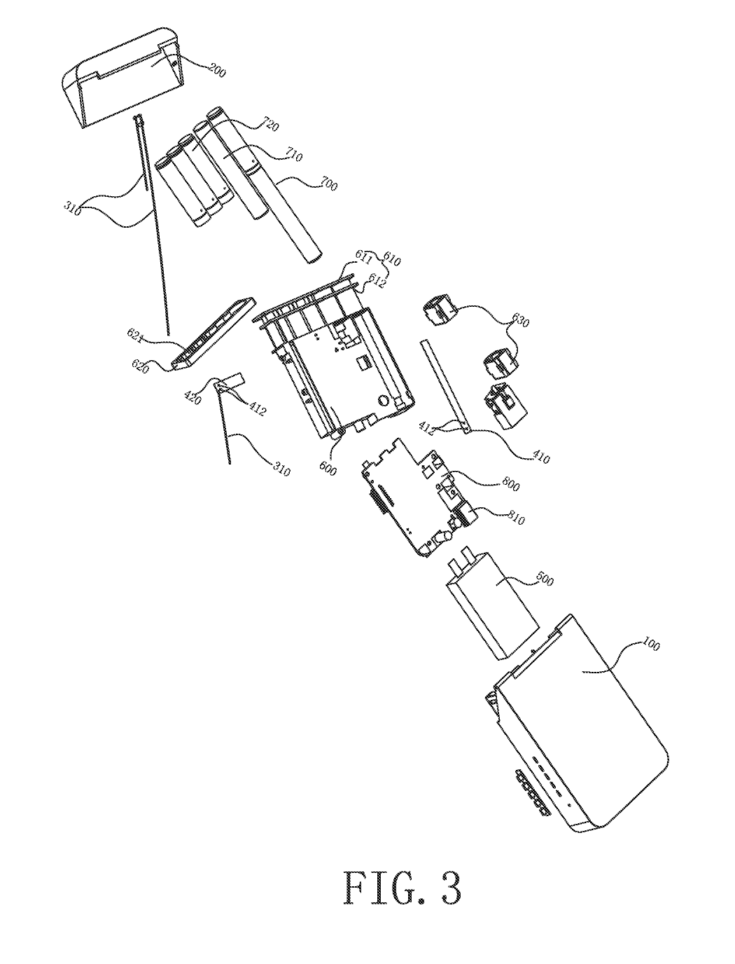

As shown in FIG. 3, the electronic cigarette case further comprises a PCB 800 for controlling the illumination circuit and a charging circuit etc., and is provided with a USB connector 810. The PCB 800 is mounted on the frame assembly.

The above embodiment is only to illustrate the best mode of the invention, not to limit the scope of the present invention. Spirit of variations or modifications made to the equivalent, should be covered within the scope of the present invention.

1. An electronic cigarette case, comprising a case body and a case cover connected to each other, wherein an illuminating lamp is set within the case cover, a battery is set within the case body, the illuminating lamp and the battery are connected to form a illumination circuit, the illumination circuit is provided with a first switch contact and a second switch contact both of which are independent and electrically touchable with each other, the case cover is further provided with a cover cam, the cover cam is able to push the first switch contact away from the second switch contact when the case cover is closed.

2. The electronic cigarette case according to claim 1, wherein a frame assembly is set in the case cover, the first switch contact and the second switch contact each have one end thereof respectively fixed on the frame assembly, the other end of the first switch contact extends to an opposite position to the cover cam.

3. The electronic cigarette case according to claim 2, wherein the end of each the first switch contact and the second switch contact is fixed on the frame assembly respectively via two fixed pivots.

4. The electronic cigarette case according to claim 2, wherein the end of each the first switch contact and the second switch contact is fixed on the frame assembly respectively by rivets, welding, or screws.

5. The electronic cigarette case according to claim 1, wherein the first switch contact and the second switch contact perpendicularly cross each other.

6. The electronic cigarette case according to claim 1, wherein the cover cam is set at a junction of the case cover with the case body.

7. The electronic cigarette case according to claim 1, wherein the case cover is engaged with the case body by a hinge, and the cover cam is set to an inner wall of the case cover corresponding to the hinge.

8. The electronic cigarette case according to claim 1, wherein the cover cam is a protrusion with an arc surface of smooth transition.

9. The electronic cigarette case according to claim 2, wherein the frame assembly comprises an electronic cigarette holder for placing the electronic cigarette.

10. The electronic cigarette case according to claim 9, wherein the electronic cigarette holder defines multiple holes adapted for the electronic cigarette, power rod of the electronic cigarette, or atomizer of the electronic cigarette.

11. The electronic cigarette case according to claim 10, wherein a frame insulator is provided on the electronic cigarette holder, and the frame insulator in center defines a through hole adapted for the electronic cigarette, power rod of the electronic cigarette, or an atomizer of the electronic cigarette.

12. The electronic cigarette case according to claim 11, wherein the electronic cigarette holder comprises an upper holder and a lower holder, and the frame insulator is placed between the upper holder and the lower holder.

13. The electronic cigarette case according to claim 9, wherein the frame assembly further comprises an insulator of the power rod adapted for the power rod of the electronic cigarette.

14. The electronic cigarette case according to claim 11, wherein the frame insulator is made from silica gel.

15. The electronic cigarette case according to claim 1, wherein the illuminating lamp is an LED (light emitting diode) lamp.

16. The electronic cigarette case according to claim 11, wherein the insulator of the power rod is made from silica gel.
